(19) United States
(12) Patent Application Publication
(10) Pub. No.: US 2026/0207310 A1
(43) Pub. Date: Jul. 23, 2026

(54) METHOD AND APPARATUS FOR CONTROLLING ORAL CLEANING DEVICE, AND STORAGE MEDIUM

(71) Applicant: NINGBO SEAGO ELECTRIC CO,. LTD., Ningbo City (CN)

(72) Inventors: Huiming Liu, Ningbo City (CN); Yanzhong Cai, Ningbo City (CN); Zhuting Dong, Ningbo City (CN); Li Gao, Ningbo City (CN)

(21) Appl. No.: 19/319,790

(22) Filed: Sep. 5, 2025

(30) Foreign Application Priority Data
Jan. 17, 2025 (CN) 202510080789.4

(51) Int. Cl. A61C 17/22

(52) U.S. Cl. CPC A61C 17/221

(57) ABSTRACT

The present disclosure relates to the technical field of oral care, and includes a method and an apparatus for controlling an oral cleaning device, and a storage medium. The cleaning component of the oral cleaning device is controlled to perform the swinging action when the instruction to start the target swing-vibration mode is obtained; and during performing the swinging action, the cleaning component is controlled to perform the vibrating action at different vibration intensities based on the operating time of the target swing-vibration mode.

### CROSS-REFERENCE TO RELATED APPLICATIONS

The present disclosure claims the priority to the Chinese patent application No. 202510080789.4 filed with the Chinese Patent Office on Jan. 17, 2025, and entitled “METHOD AND APPARATUS FOR CONTROLLING ORAL CLEANING DEVICE, AND STORAGE MEDIUM”, the contents of which are incorporated herein by reference in entirety.

### TECHNICAL FIELD

The present disclosure relates to the technical field of oral care, and in particular, to a method and an apparatus for controlling an oral cleaning device, and a storage medium.

### BACKGROUND ART

With the development of automation technology, electric toothbrushes and other oral cleaning devices that automatically clean oral cavities are favored by more and more users. Currently, oral cleaning devices can have various operating modes to meet different cleaning needs of users.

However, various current operating modes still have a limited cleaning degree, leading to the problem that the oral cleaning devices fail to effectively clean the oral cavities.

### SUMMARY

In view of this, the present disclosure provides a method and an apparatus for controlling an oral cleaning device, and a storage medium, which can avoid a potential damage to gums and teeth caused by a continuous high-intensity vibration, thereby reducing a risk of problems such as gum bleeding and tooth sensitivity caused by improper brushing, improving a cleaning efficiency, and providing more accurate and flexible cleaning capabilities.

According to an aspect of the present disclosure, a method for controlling an oral cleaning device is provided. The method comprises:
controlling a cleaning component of the oral cleaning device to perform a swinging action when an instruction to start a target swing-vibration mode is obtained; and
controlling the cleaning component to perform a vibrating action at different vibration intensities based on operating time of the target swing-vibration mode during performing the swinging action.

In a possible implementation, the controlling the cleaning component to perform the vibrating action at different vibration intensities based on the operating time of the target swing-vibration mode during performing the swinging action, comprises:
controlling the cleaning component to perform the vibrating action at a first vibration intensity in response to the operating time falls within a preset first vibration period during performing the swinging action; and
controlling the cleaning component to perform the vibrating action at a second vibration intensity in response to the operating time falls within a preset second vibration period during performing the swinging action.

The first vibration period and the second vibration period alternate with each other, and a sum of durations of the first vibration period and the second vibration period is less than or equal to a duration of a swinging period of the swinging action. The first vibration intensity is different from the second vibration intensity, and/or a variation manner of the first vibration intensity is different from a variation manner of the second vibration intensity.

In a possible implementation, the first vibration intensity corresponding to the first vibration period varies or remains unvaried; and/or
the second vibration intensity corresponding to the second vibration period varies or remains unvaried.

In a possible implementation, the first vibration intensity corresponding to the first vibration period varying, comprises: a first sub-vibration intensity within a first sub-period of the first vibration period, a second sub-vibration intensity within a second sub-period of the first vibration period, and the first sub-period and the second sub-period alternating with each other within the first vibration period, and the first sub-vibration intensity being different from the second sub-vibration intensity.

The second vibration intensity corresponding to the second vibration period varying, comprises: a third sub-vibration intensity within a third sub-period of the second vibration period, a fourth sub-vibration intensity within a fourth sub-period of the second vibration period, and the third sub-period and the fourth sub-period alternating with each other within the second vibration period, and the third sub-vibration intensity being different from the fourth sub-vibration intensity.

In a case where the first vibration intensity is greater than the second vibration intensity, the first sub-vibration intensity is greater than the third sub-vibration intensity and the fourth sub-vibration intensity; and the second sub-vibration intensity is greater than the third sub-vibration intensity and the fourth sub-vibration intensity.

In a case where the first vibration intensity is less than the second vibration intensity, the first sub-vibration intensity is less than the third sub-vibration intensity and the fourth sub-vibration intensity; and the second sub-vibration intensity is less than the third sub-vibration intensity and the fourth sub-vibration intensity.

In a possible implementation, the controlling the cleaning component to perform the vibrating action at different vibration intensities based on the operating time of the target swing-vibration mode during performing the swinging action, comprises:
controlling the cleaning component to perform the vibrating action at a vibration intensity that continuously varies based on the operating time falling within a preset third vibration period during performing the swinging action.

A duration of the third vibration period is less than or equal to a duration of a swinging period of the swinging action.

In a possible implementation, the vibration intensity continuously varies within the third vibration period comprises: continuously increasing from a third vibration intensity to a fourth vibration intensity, and then continuously decreasing from the fourth vibration intensity to the third vibration intensity.

In a possible implementation, the oral cleaning device comprises at least two swing-vibration modes, and different swing-vibration modes correspond to different swing-vibration strategies. The swing-vibration strategy indicates a manner of performing the swinging action and the vibrating action. Correspondingly,
the method further comprises:
receiving a mode selection operation for the target swing-vibration mode in the at least two swing-vibration modes; and
generating the instruction to start the target swing-vibration mode based on the mode selection operation, so as to control the cleaning component to perform the swinging action and the vibrating action according to a swing-vibration strategy corresponding to the target swing-vibration mode.

In a possible implementation, the target swing-vibration mode comprises at least two swing-vibration levels, and different swing-vibration levels in a same swing-vibration mode correspond to different vibration intensities; and
correspondingly,
the generating the instruction to start the target swing-vibration mode based on the mode selection operation, comprises:
receiving a level selection operation for a target swing-vibration level in the at least two swing-vibration levels; and
generating the instruction to start the target swing-vibration mode based on the mode selection operation and the level selection operation, so as to control the cleaning component to perform the swinging action and the vibrating action according to the swing-vibration strategy corresponding to the target swing-vibration mode and a vibration intensity corresponding to the target swing-vibration level.

According to another aspect of the present disclosure, an apparatus for controlling an oral cleaning device is provided. The apparatus comprises: a processor; and a memory for storing instructions executable by the processor. The processor is configured to implement the above method when executing the instructions stored in the memory.

The processor comprises a main control chip and a driving chip connected to the main control chip. The driving chip is connected to a driving structure in the cleaning component.

The main control chip is configured to send the instruction to start the target swing-vibration mode to the driving chip.

Correspondingly, the driving chip is configured to: control the cleaning component of the oral cleaning device to perform the swinging action when obtaining the instruction to start the target swing-vibration mode; and control the cleaning component to perform the vibrating action at different vibration intensities based on the operating time of the target swing-vibration mode during performing the swinging action.

In a possible implementation, the driving chip comprises a processing unit and driving units. Correspondingly,
the main control chip is configured to send the instruction to start the target swing-vibration mode to the processing unit based on a preset communication protocol. The instruction carries mode data corresponding to the target swing-vibration mode; and
the processing unit is configured to: decode the instruction when obtaining the instruction to start the target swing-vibration mode based on the preset communication protocol; and control the driving units to drive the driving structure to move based on decoded information, so that the cleaning component performs the swinging action and the vibrating action.

In a possible implementation, the driving structure comprises sensors, and sensing data collected by the sensors are configured to indicate a movement position of the driving structure. The sensors are in one-to-one correspondence with the driving units. Correspondingly,
the driving units are further configured to obtain sensing data collected by respective sensors and send the sensing data to the processing unit; and
the processing unit is further configured to analyze and process the sensing data when receiving the sensing data fed back by the driving units, and to control the driving units to drive the driving structure to move according to the target swing-vibration mode based on a processing result.

In a possible implementation, the driving chip comprises driving units connected to the main control chip. Correspondingly,
the main control chip is configured to send the instruction to start the target swing-vibration mode to the driving units; the instruction is configured to indicate a movement manner of the driving structure; and
the driving units are configured to drive the driving structure to move based on the instruction when obtaining the instruction to start the target swing-vibration mode, so that the cleaning component performs the swinging action and the vibrating action.

In a possible implementation, the driving structure comprises sensors, and sensing data collected by the sensors are configured to indicate a movement position of the driving structure. The sensors are in one-to-one correspondence with the driving units. Correspondingly,
the driving units are further configured to obtain sensing data collected by respective sensors, analyze the sensing data to obtain analyzed sensing data, and send the analyzed sensing data to the main control chip; and
the main control chip is further configured to process the analyzed sensing data when receiving the analyzed sensing data fed back by the driving units, and to control the driving units to drive the driving structure to move according to the target swing-vibration mode based on a processing result.

According to another aspect of the present disclosure, a non-volatile computer-readable storage medium is provided, on which computer program instructions are stored. The computer program instructions, when executed by a processor, implement the above method.

According to another aspect of the present disclosure, a computer program product is provided. The computer program product comprises computer-readable code, or a non-volatile computer-readable storage medium carrying the computer-readable code. When the computer-readable code runs in a processor of an electronic device, the processor in the electronic device executes the above method.

The cleaning component of the oral cleaning device is controlled to perform the swinging action when the instruction to start the target swing-vibration mode is obtained; and during performing the swinging action, the cleaning component is controlled to perform the vibrating action at different vibration intensities based on the operating time of the target swing-vibration mode. Therefore, the independent control of the vibration intensity through the time logic is achieved, so that the cleaning component can achieve the cross-variation of the vibration intensity according to the operating time during the entire swinging period, thereby achieving the strong-weak alternation of the vibration intensity while swinging, and reducing an excessive stimulation or damage possibly caused by a single-intensity vibration. A strong vibration is capable of providing effectively cleaning, and a weak vibration gives an oral cavity a certain rest time. This avoids a potential damage to gums and teeth caused by a continuous high-intensity vibration, thereby reducing a risk of problems such as gum bleeding and tooth sensitivity caused by improper brushing, improving a cleaning efficiency, and providing more accurate and flexible cleaning capabilities.

Other features and aspects of the present disclosure will become clear from the detailed description of the exemplary embodiments with reference to the drawings below.

### BRIEF DESCRIPTION OF DRAWINGS

The drawings included in the description and forming a part of the description illustrate exemplary embodiments, features and aspects of the present disclosure together with the description, and are used to explain the principles of the present disclosure.

FIG. 1 shows a schematic diagram of an oral cleaning device according to an embodiment of the present disclosure;

FIG. 2 shows a schematic diagram of a swinging action and a vibrating action according to an embodiment of the present disclosure;

FIG. 3 shows a schematic diagram of a driving waveform for driving a vibration of a cleaning component according to an embodiment of the present disclosure;

FIG. 4 shows a flowchart of a method for controlling an oral cleaning device according to an embodiment of the present disclosure;

FIG. 5 shows a schematic diagram of driving waveforms for driving a vibration of a cleaning component according to another embodiment of the present disclosure;

FIG. 6 shows a schematic diagram of driving waveforms for driving a vibration of a cleaning component according to yet another embodiment of the present disclosure;

FIG. 7 shows a schematic diagram of driving waveforms for driving a vibration of a cleaning component according to yet another embodiment of the present disclosure;

FIG. 8 shows a schematic diagram of driving waveforms for driving a vibration of a cleaning component according to yet another embodiment of the present disclosure;

FIG. 9 shows a schematic diagram of a driving waveform for driving a vibration of a cleaning component according to yet another embodiment of the present disclosure;

FIG. 10 shows a block diagram of an apparatus for controlling an oral cleaning device according to an embodiment of the present disclosure; and

FIG. 11 shows a block diagram of an apparatus for controlling an oral cleaning device according to another embodiment of the present disclosure.

### DETAILED DESCRIPTION OF EMBODIMENTS

Various exemplary embodiments, features, and aspects of the present disclosure will be described in detail below with reference to the drawings. Same reference numerals in the drawings denote elements with same or similar functions. Although various aspects of the embodiments are shown in the drawings, the drawings are not necessarily drawn to scale unless specifically stated.

Herein, the term “exemplary” is used exclusively to mean “serving as an example, embodiment, or illustration”. Any embodiment described herein as “exemplary” should not be construed as superior to or better than other embodiments.

Additionally, to better describe the present disclosure, numerous specific details are set forth in the following detailed description. Those skilled in the art should understand that the present disclosure can still be implemented without some specific details. In some examples, methods, means, elements, and circuits well known to those skilled in the art are not described in detail to highlight the gist of the present disclosure.

In the present disclosure, an oral cleaning device refers to an electronic device that is capable of achieving oral cleaning functions through electric control. The types of oral cleaning devices include, but are not limited to, electric toothbrushes, handle parts of electric toothbrushes, electric water flossers, etc. The types of oral cleaning devices are not limited in the present disclosure.

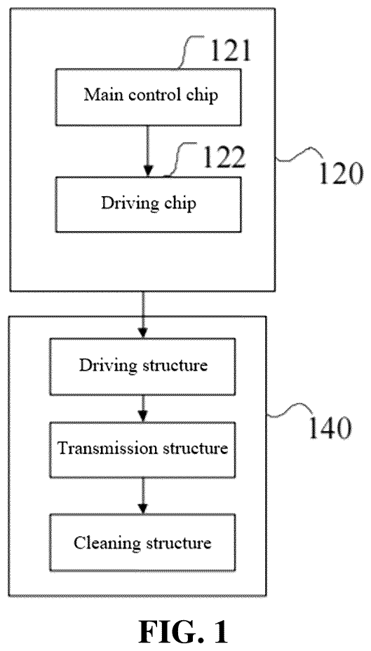

FIG. 1 shows a schematic diagram of an oral cleaning device according to an embodiment of the present disclosure, in which the oral cleaning device is illustrated as an example of an electric toothbrush. As shown in FIG. 1, the oral cleaning device 100 at least includes a control module 120 and a cleaning component 140.

The cleaning component 140 refers to a part of the oral cleaning device used for cleaning an oral cavity. Illustratively, the cleaning component 140 includes a driving structure and a cleaning structure connected to the driving structure. The driving structure drives the cleaning structure to move during operation to achieve an oral cleaning. The driving structure includes a motor and a transmission part for connecting the motor and the cleaning structure in a transmission way. The cleaning structure can be a toothbrush head in an electric toothbrush.

In an example, the motor includes a servo motor. In this case, a sufficient torque can be provided by adjusting a power output of the servo motor. During operation, the transmission part converts a torque of the driving structure into a force required for swinging and vibrating of the toothbrush head, so that bristles on the toothbrush head swing and/or vibrate, thereby enabling the toothbrush head to maintain a strong brushing effect during the swinging and/or vibrating, and thus effectively removing food residues and dental plaques.

The control module 120 is electrically connected to the driving structure in the cleaning component 140, and is configured to generate a driving waveform for the driving structure, so that the driving structure operates according to the driving waveform. The control module 120 is further configured for an overall control of the oral cleaning device. Control contents include, but are not limited to, controlling the device to turn on or off, controlling the cleaning component 140 to start or stop operating, controlling a current operating mode of the cleaning component 140, etc. The control contents of the control module 120 are not limited in this embodiment.

In this embodiment, the operating modes of the cleaning component 140 include swing-vibration mode(s), which refer to mode(s) in which the cleaning structure performs a swinging action within a preset swinging amplitude and simultaneously performs a vibrating action during the swinging. The swinging action is achieved by a reciprocating movement of the motor that drives the cleaning component to move, and the vibrating action is achieved by a small-amplitude reciprocating movement centered on each movement position of the motor during the reciprocating movement. An amplitude of the reciprocating movement corresponding to the swinging action is greater than an amplitude of the reciprocating movement corresponding to the vibrating action, and a frequency of the reciprocating movement corresponding to the swinging action is less than a frequency of the reciprocating movement corresponding to the vibrating action.

Optionally, a value range of a swinging amplitude may be from 0 degrees to 120 degrees. In other implementations, an upper limit value of the value range of the swinging amplitude can also be greater than 120 degrees or less than 120 degrees. The setting manner of the value range of the swinging amplitude is not limited in this embodiment. A value range of a swinging frequency of the swinging action can be from 0.1 times per second to 120 times per second. In an actual implementation, an upper limit value and a lower limit value of the value range of the swinging frequency of the swinging action can also be other values. The setting manner of the value range of the swinging frequency of the swinging action is not limited in this embodiment.

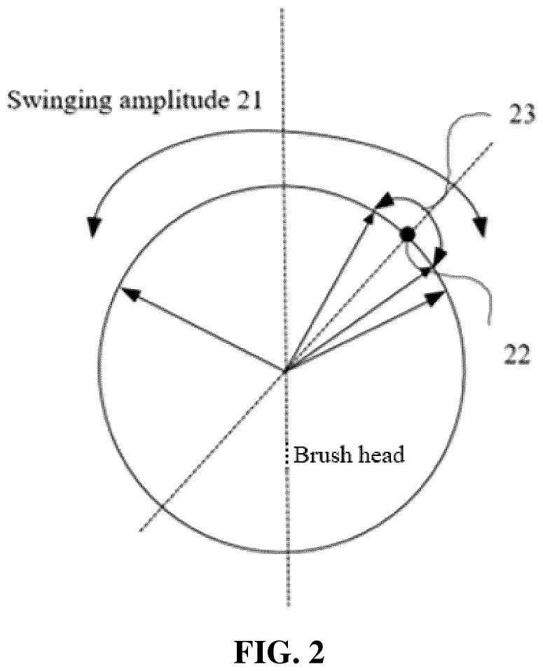

Referring to a top view of the toothbrush head shown in FIG. 2, the swinging action has a swinging amplitude 21. When the cleaning structure swings to position 22 during performing the swinging action, a corresponding vibrating action at position 22 is a reciprocating movement centered on position 22. An amplitude 23 of this reciprocating movement is less than the swinging amplitude 21, and a frequency of this reciprocating movement is greater than a frequency of the swinging action.

Optionally, one or at least two swing-vibration modes are included, and different swing-vibration modes correspond to different swing-vibration strategies. The swing-vibration strategy is used to indicate a manner of performing the swinging action and the vibrating action. For example, the swing-vibration strategy is used to indicate the swinging amplitude and/or swinging frequency of the swinging action. For another example, the swing-vibration strategy is used to indicate a vibration period, a vibration intensity, etc., of the vibrating action. The contents of the swing-vibration strategy are not limited in this embodiment.

In this embodiment, the vibration intensity is positively correlated with a pulse duration of the driving waveform for driving the vibration of the cleaning component, that is, the longer the pulse duration, the greater the vibration intensity.

Optionally, a value range of the vibration frequency of the vibrating action can be from 1 Hz to 1000 Hz. In an actual implementation, an upper limit value and a lower limit value of the vibration frequency of the vibrating action can also be other values. The setting manner of the value range of the vibration frequency of the vibrating action is not limited in this embodiment. A value range of the vibration intensity of the vibrating action can be from 0% to 100% of a maximum intensity, where the maximum intensity is determined based on a maximum value of the pulse duration. In an actual implementation, the upper limit value and the lower limit value of the value range of the vibration intensity can also be other values. The setting manner of the value range of the vibration intensity is not limited in this embodiment.

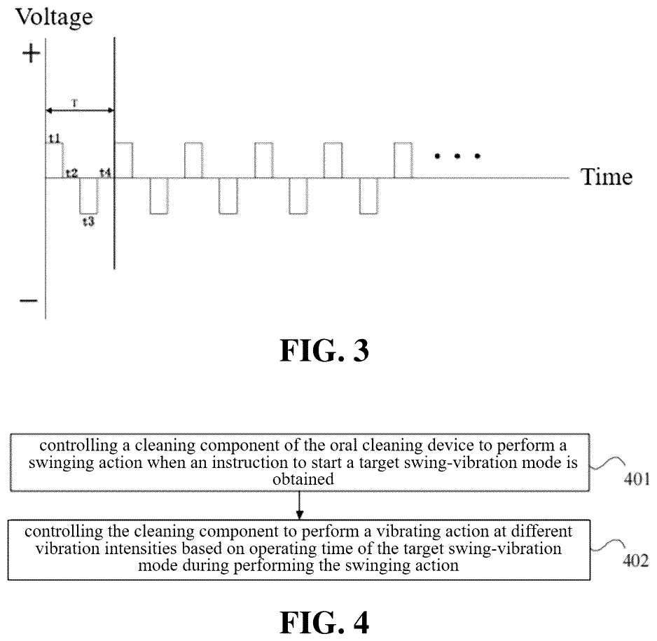

For example, referring to the driving waveform for driving the vibration of the cleaning component shown in FIG. 3, FIG. 3 takes the driving waveform as a square wave as an example for illustration. In an actual implementation, the driving waveform can also be other types of signals such as a sawtooth wave. The type of the driving waveform is not limited in this embodiment. As can be seen from FIG. 3, a driving period T of the driving waveform is t1+t2+t3+t4 (T=t1+t2+t3+t4), where the pulse duration refers to a duration when the driving waveform remains non-zero, i.e., t1 and t3. In this case, the larger t1 and t3 are, the greater the vibration intensity of the cleaning component; the smaller t1 and t3 are, the smaller the vibration intensity of the cleaning component. The frequency of the vibrating action is negatively correlated with the duration of the driving period T, that is, a number of vibrating actions can be adjusted by adjusting the duration of T. The longer the duration of T, the fewer the number of the vibrating actions; the shorter the duration of T, the larger the number of the vibrating actions. Optionally, t1 is equal to t3, and t2 is equal to t4.

The swing-vibration mode can be selected through a human-computer interaction control on the oral cleaning device. The human-computer interaction control is connected to the control module 120, so that when the human-computer interaction control receives a mode selection operation, the control module 120 generates an instruction to start a target swing-vibration mode corresponding to the mode selection operation.

Exemplarily, the human-computer interaction control includes at least one of, but is not limited to, the following: touch display screens, physical buttons, etc. The implementation of the human-computer interaction control is not limited in this embodiment.

Optionally, at least one swing-vibration mode includes at least two swing-vibration levels, and different swing-vibration levels in a same swing-vibration mode correspond to different vibration intensities. In other words, for the same swing-vibration mode, except for parameters affecting the vibration intensity, all other operating parameters of different swing-vibration levels are same.

The swing-vibration levels can also be selected through the human-computer interaction control on the oral cleaning device. When the human-computer interaction control receives a level selection operation, the control module 120 generates an instruction to start a target level corresponding to the level selection operation.

Optionally, the oral cleaning device 100 can further include other operating mode(s), such as a swinging mode and/or a vibrating mode. The swinging mode refers to a mode in which the swinging action is performed without the vibrating action, and the vibrating mode refers to a mode in which only the vibrating action is performed without the swinging action. The implementation of the operating modes is not limited in this embodiment.

Accordingly, different operating modes can be selected through the human-computer interaction control. Further, each operating mode can also include at least two operating levels, which are selected through the human-computer interaction control. The selection method of the operating modes is not limited in this embodiment.

In other embodiments, the operating mode, the swing-vibration mode, the operating level, and the swing-vibration level can also be selected by other electronic device(s) communicatively connected to the oral cleaning device, and corresponding instructions are sent to the oral cleaning device. The selection method of the modes and the levels is not limited in this embodiment.

Exemplarily, the oral cleaning device includes a toothbrush head and a toothbrush handle. The control module, the driving structure in the cleaning component, and the human-computer interaction control can be arranged in the brush handle, and the cleaning structure is implemented as the brush head.

In this embodiment, the control module 120 is configured to: control the cleaning component of the oral cleaning device to perform the swinging action when obtaining an instruction to start the target swing-vibration mode; and control the cleaning component to perform the vibrating action at different vibration intensities based on operating time of the target swing-vibration mode during performing the swinging action.

During performing the swinging action, the vibration intensity is independently controlled through time logic, thus enabling cross-variation of the vibration intensity according to the operating time throughout a swinging period. In other words, the variation of the vibration intensity is independently controlled with the time of one swinging period as a main axis, so that the vibration intensity and the swinging amplitude form an alternating or superimposed movement effect within a same time period, rather than the vibration intensity varying linearly with a swinging position, thereby forming a unique cross-vibration design. This cross-vibration design is capable of more effectively covering a tooth surface area and an interdental area. Especially in a case where the swinging amplitude is fixed or difficult to adjust directly, the dynamic variation of the vibration intensity is still capable of achieving a targeted cleaning. Moreover, by adding a time sequence of a “weak-strong” variation of the vibration intensity within the swinging period, the problem of gum irritation or sensitivity caused by continuous high-intensity vibration is avoided, the cleaning efficiency is improved, and more precise and flexible cleaning capabilities are provided.

In an example, the control module 120 includes a main control chip 121 and a driving chip 122 connected to the main control chip 121. The driving chip 122 is connected to the driving structure in the cleaning component 140.

The main control chip is configured to coordinate and control various functions of the oral cleaning device to ensure that the electronic device is capable of operating as expected. Optionally, the main control chip can be a microcontroller unit (MCU), a digital signal controller (DSC), an application specific integrated circuit (ASIC), etc. The implementation of the main control chip is not limited in this embodiment.

In this embodiment, the main control chip is configured to obtain the instruction to start the target swing-vibration mode and send the instruction to start the target swing-vibration mode to the driving chip. Optionally, the main control chip generates the instruction to start the target swing-vibration mode based on the mode selection operation, or the instruction to start the target swing-vibration mode is sent to the main control chip by other devices. The way in which the main control chip obtains the instruction to start the target swing-vibration mode is not limited in this embodiment.

The driving chip is configured to control the driving structure in the oral cleaning device to ensure that the driving structure operates according to a preset mode and speed. Optionally, the driving chip can be an integrated circuit (IC), etc., and the implementation of the driving chip is not limited in this embodiment.

In this embodiment, the driving chip is configured to control the cleaning component of the oral cleaning device to perform the swinging action when obtaining the instruction to start the target swing-vibration mode; and control the cleaning component to perform the vibrating action at different vibration intensities based on the operating time of the target swing-vibration mode during performing the swinging action.

Optionally, the driving chip includes, but is not limited to, the following two implementations.

In a first implementation, the driving chip includes a processing unit and driving units. In this case, the main control chip controls the driving chip to drive the driving structure based on a preset communication protocol. The preset communication protocol can be a universal asynchronous receiver/transmitter (UART) protocol or an inter-integrated circuit (I2C) protocol. The implementation of the communication protocol is not limited in this embodiment.

In this case, the driving chip includes the processing unit with processing capabilities, so as to achieve the control of the driving units. Optionally, the processing unit can be an MCU or a DSC, etc. The implementation of the processing unit is not limited in this embodiment. The driving unit is configured to convert a received control signal (such as a PWM signal) into an appropriate voltage and current to drive the driving structure to operate. Optionally, the driving unit can be a motor driver.

Specifically, the main control chip is configured to send the instruction to start the target swing-vibration mode to the processing unit based on the preset communication protocol. The instruction carries mode data corresponding to the target swing-vibration mode.

Optionally, the mode data is used to indicate operating parameters of the driving structure when implementing the swinging action and the vibrating action corresponding to the target swing-vibration mode. For example, the mode data includes a swinging angle, the swinging frequency, the vibration intensity, and/or the vibration frequency, etc. The implementation of the mode data is not limited in this embodiment.

Correspondingly, the processing unit is configured to decode the instruction when obtaining the instruction to start the target swing-vibration mode based on the preset communication protocol; and control the driving units to drive the driving structure to move based on decoded information, so that the cleaning component performs the swinging action and the vibrating action.

In this embodiment, the driving structure includes sensors, and sensing data collected by the sensors is used to indicate a movement position of the driving structure. The sensors are in one-to-one correspondence with the driving units. Exemplarily, the driving structure is a servo motor, and the sensors mounted on the servo motor include three Hall sensors. Sensing data of the three Hall sensors is used to indicate a movement position of the servo motor. In this case, the driving units also include three driving units that are in one-to-one correspondence with the three Hall sensors.

Correspondingly, the driving units are further configured to obtain sensing data collected by respective sensors and send the sensing data to the processing unit.

Correspondingly, the processing unit is further configured to analyze and process the sensing data when receiving the sensing data fed back by the driving units, and to control the driving units to drive the driving structure to move according to the target swing-vibration mode based on a processing result.

Analyzing the sensing data includes: converting the sensing data into information understandable by the processing unit to enable the processing unit to perform subsequent processing based on the understandable information.

Processing the sensing data includes: comparing a movement position indicated by the analyzed information with an expected position; and determining a speed and/or an acceleration, etc., of the driving structure based on a difference between the movement position and the expected position. The processing contents of the sensing data are not limited in this embodiment.

In a second implementation, the main control chip directly controls a driving unit in the driving chip. In this case, the driving chip includes driving units connected to the main control chip, and optionally, a processing unit may not be provided in the driving chip. The related description of the main control chip and the driving units is detailed in the above embodiments, and will not be repeated here.

In this embodiment, the main control chip is configured to send the instruction to start the target swing-vibration mode to the driving units, and the instruction is configured to indicate the movement manner of the driving structure. For example, the instruction to start the target swing-vibration mode is a PWM signal.

Correspondingly, the driving units are configured to drive the driving structure to move based on the instruction when obtaining the instruction to start the target swing-vibration mode, so that the cleaning component performs the swinging action and the vibrating action.

According to the above embodiments, the driving structure may further include sensors. Correspondingly, the driving units are further configured to obtain sensing data collected by respective sensors, analyze the sensing data to obtain analyzed sensing data, and send the analyzed sensing data to the main control chip.

The related description of analyzing the sensing data is detailed in the above embodiments, and will not be repeated here.

Correspondingly, the main control chip is further configured to process the analyzed sensing data when receiving the analyzed sensing data fed back by the driving units, and control the driving units to drive the driving structure to move according to the target swing-vibration mode based on a processing result. The related description of processing the sensing data is detailed in the above embodiments, and will not be repeated here.

In this case, the main control chip can directly control the driving units without additionally providing a processing unit.

Optionally, the oral cleaning device can further include other components, for example, a control component for at least starting or closing the oral cleaning device, for another example, a power supply component for providing electric energy to the oral cleaning device, etc. The specific structures of the oral cleaning device are not listed one by one in this embodiment.

A method for controlling the oral cleaning device provided in the present disclosure is described in detail below. In this embodiment, the method is illustrated as an example for use in the oral cleaning device shown in FIG. 1, specifically in the control module 120.

FIG. 4 shows a flowchart of a method for controlling an oral cleaning device according to an embodiment of the present disclosure. As shown in FIG. 4, the method includes step 401 and step 402.

In step 401, when an instruction to start a target swing-vibration mode is obtained, a cleaning component of the oral cleaning device is controlled to perform a swinging action.

Optionally, the instruction to start the target swing-vibration mode can be generated by the oral cleaning device or sent by other devices communicatively connected to the oral cleaning device. The method of obtaining the instruction is not limited in this embodiment.

In an example where the instruction to start the target swing-vibration mode is generated by the oral cleaning device, if the oral cleaning device includes at least two swing-vibration modes, obtaining the instruction to start the target swing-vibration mode includes:
receiving a mode selection operation for the target swing-vibration mode in the at least two swing-vibration modes; and generating the instruction to start the target swing-vibration mode based on the mode selection operation, so as to control the cleaning component to perform the swinging action and a vibrating action according to a swing-vibration strategy corresponding to the target swing-vibration mode.

Different swing-vibration modes correspond to different swing-vibration strategies. The swing-vibration strategy is used to indicate a manner of performing the swinging action and the vibrating action. The oral cleaning device pre-stores a correspondence between each swing-vibration mode and a swing-vibration strategy. After receiving the instruction to start the target swing-vibration mode, the correspondence is read to obtain the swing-vibration strategy corresponding to the target swing-vibration mode.

Exemplarily, each swing-vibration strategy includes a swinging amplitude, a swinging frequency, and cross-vibration manner(s). The cross-vibration manner is used to indicate a manner in which a vibration intensity varies non-linearly with operating time of the swing-vibration mode. A variety of cross-vibration manners are provided in this embodiment, which are specifically introduced in detail below, and will not be repeated here in this embodiment.

Optionally, the target swing-vibration mode includes at least two swing-vibration levels, and different swing-vibration levels under a same swing-vibration mode correspond to different vibration intensities. In this case, generating the instruction to start the target swing-vibration mode based on the mode selection operation includes: receiving a level selection operation for a target swing-vibration level in the at least two swing-vibration levels; and generating the instruction to start the target swing-vibration mode based on the mode selection operation and the level selection operation, so as to control the cleaning component to perform the swinging action and the vibrating action according to the swing-vibration strategy corresponding to the target swing-vibration mode and a vibration intensity corresponding to the target swing-vibration level.

For example, in an example where the oral cleaning device receives the mode selection operation and the level selection operation through a touch display screen, the oral cleaning device displays a mode selection interface through the touch display screen in this case. The mode selection interface includes mode information of the swing-vibration modes, and the mode information can be mode names, or mode icon information, etc. The implementation of the mode information is not limited in this embodiment. When a mode selection operation acting on any mode information in the mode selection interface is received, a level selection interface is displayed. The level selection interface includes level information of the swing-vibration levels corresponding to the target swing-vibration mode indicated by the mode selection operation. The level information can be level names, or level icon information, etc. The implementation of the level information is not limited in this embodiment. When a level selection operation acting on any level information in the level selection interface is received, the instruction to start the target swing-vibration mode is generated.

In other implementations, a user can also select both the target swing-vibration mode and the target swing-vibration level. For example, three swing-vibration modes are included, and each swing-vibration mode includes two swing-vibration levels. A brush handle of the oral cleaning device is provided with six physical buttons, and the physical buttons respectively correspond to the swing-vibration levels of the swing-vibration modes. In this case, when a selection operation of one of the physical buttons is received, a corresponding target swing-vibration mode and a corresponding target swing-vibration level are selected. For another example, three swing-vibration modes are included, and each swing-vibration mode includes 2 swing-vibration levels. The brush handle of the oral cleaning device is provided with one physical button. If a single selection operation acting on this physical button is received within a preset time requirement, a swing-vibration level 1 of a swing-vibration mode 1 is selected; if two selection operations acting on this physical button are received within the preset time requirement, a swing-vibration level 2 of the swing-vibration mode 1 is selected; if three selection operations acting on this physical button are received within the preset time requirement, a swing-vibration level 1 of a swing-vibration mode 2 is selected, ..., in a repetitive manner. That is, different numbers of selection operations acting on the same physical button within the preset time requirement respectively correspond to the swing-vibration levels of the swing-vibration modes. In this case, a corresponding target swing-vibration mode and a corresponding target swing-vibration level are determined based on the number of selection operations acting on the physical button received within the preset time requirement. In an actual implementation, the manner of selecting the target swing-vibration mode and the target swing-vibration level can also be other manners. The manner of selecting the target swing-vibration mode and the target swing-vibration level is not limited in this embodiment.

After obtaining the instruction to start the target swing-vibration mode, the oral cleaning device reads the swing-vibration strategy corresponding to the target swing-vibration mode, and controls the cleaning component of the oral cleaning device to perform the swinging action according to a swinging manner indicated by the swing-vibration strategy.

For example, if the swing-vibration strategy includes the swinging amplitude and the swinging frequency of the swinging action, the cleaning component of the oral cleaning device is controlled to perform the swinging action according to the swinging amplitude and the swinging frequency.

In step 402, during performing the swinging action, the cleaning component is controlled to perform the vibrating action at different vibration intensities based on the operating time of the target swing-vibration mode.

Optionally, one or at least two manners, in which the oral cleaning device performs the vibrating action with the operating time of the target swing-vibration mode, are included. In a case of at least two manners are included, as known from the above, the swing-vibration strategy corresponding to the target swing-vibration mode further includes the cross-vibration manner(s). The cross-vibration manner is used to indicate the manner in which the vibration intensity varies non-linearly with the operating time of the swing-vibration mode. Each cross-vibration manner is respectively introduced below.

In a first manner, each swinging period of the swinging action includes at least two vibration periods of the vibrating action, namely a first vibration period and a second vibration period, respectively. The first vibration period and the second vibration period alternate with each other, and a sum of durations of the first vibration period and the second vibration period is less than or equal to a duration of the swinging period of the swinging action.

In the present disclosure, a vibration period ΣT of the vibrating action is a different concept from a driving period T of the vibrating action. The driving period T refers to a duration of a reciprocating movement during performing the vibrating action, and the vibration period ΣT refers to a duration of executing a same regular vibrating action. The vibration period ΣT is greater than or equal to the driving period T.

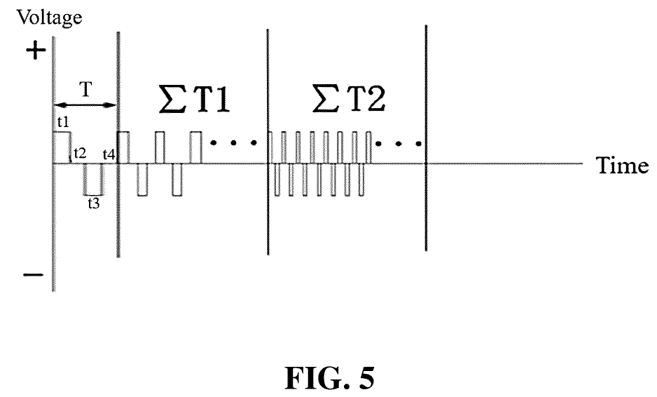

For example, referring to FIG. 5, a driving period T is t1+t2+t3+t4, and a duration of the vibrating action with a vibration intensity 1 is ΣT1, then a vibration period of the vibrating action with the vibration intensity 1 is ΣT1; a duration of the vibrating action with a vibration intensity 2 is ΣT2, then a vibration period of the vibrating action with the vibration intensity 2 is ΣT2. Driving periods T in the vibration period ΣT1 and the vibration period ΣT2 are the same or different.

Difference(s) between the first vibration period and the second vibration period include that: a first vibration intensity corresponding to the first vibration period being different from a second vibration intensity corresponding to the second vibration period; and/or a variation manner of the first vibration intensity being different from a variation manner of the second vibration intensity. The setting manners of the first vibration period and the second vibration period are not limited in this embodiment.

Correspondingly, during performing the swinging action, controlling the cleaning component to perform the vibrating action at different vibration intensities based on the operating time of the target swing-vibration mode includes: during performing the swinging action, under a condition that the operating time falls within a preset first vibration period, controlling the cleaning component to perform the vibrating action at the first vibration intensity; during performing the swinging action, under a condition that the operating time falls within a preset second vibration period, controlling the cleaning component to perform the vibrating action at the second vibration intensity.

Exemplarily, in a time sequence of each swinging period of the swinging action, the oral cleaning device generates driving waveforms respectively corresponding to the first vibration period and the second vibration period that alternate with each other. In a process of controlling the cleaning component to perform the vibrating action, the vibrating action corresponding to the driving waveform is performed with the variation of the operating time, so that when the operating time falls within the first vibration period, the cleaning component is controlled to perform the vibrating action at the first vibration intensity; when the operating time falls within the second vibration period, the cleaning component is controlled to perform the vibrating action at the second vibration intensity.

Optionally, during the swing-vibration process, the driving period within the first vibration period is the same as or different from the driving period within the second vibration period.

The first vibration intensity corresponding to the first vibration period varies or remains unvaried; and/or the second vibration intensity corresponding to the second vibration period varies or remains unvaried.

The swing-vibration modes corresponding to different implementations of the first vibration intensity and the second vibration intensity are respectively introduced below.

In mode 1, the first vibration intensity is different from the second vibration intensity, the first vibration intensity within the first vibration period remains unvaried, and the second vibration intensity within the second vibration period remains unvaried. Referring to the driving waveforms of the vibrating action shown in FIG. 5, a swinging period includes a first vibration period ΣT1 and a second vibration period ΣT2. A pulse duration of the first vibration period is greater than a pulse duration of the second vibration period. Correspondingly, the first vibration intensity of the first vibration period is greater than the second vibration intensity of the second vibration period. In the first vibration period, pulse durations of different driving periods are equal, and thus the first vibration intensity of the first vibration period remains unvaried. In the second vibration period, pulse durations of different driving periods are equal, and thus the second vibration intensity of the second vibration period remains unvaried.

FIG. 5 illustrates an example where the first vibration intensity is greater than the second vibration intensity and a swinging period includes a first vibration period and a second vibration period. In an actual implementation, the first vibration intensity can also be less than the second vibration intensity, and a swinging period can also include at least two first vibration periods and/or at least two second vibration periods. The setting manners of the first vibration intensity and the second vibration intensity, and the numbers of the first vibration period and the second vibration period in the swinging period are not limited in this embodiment.

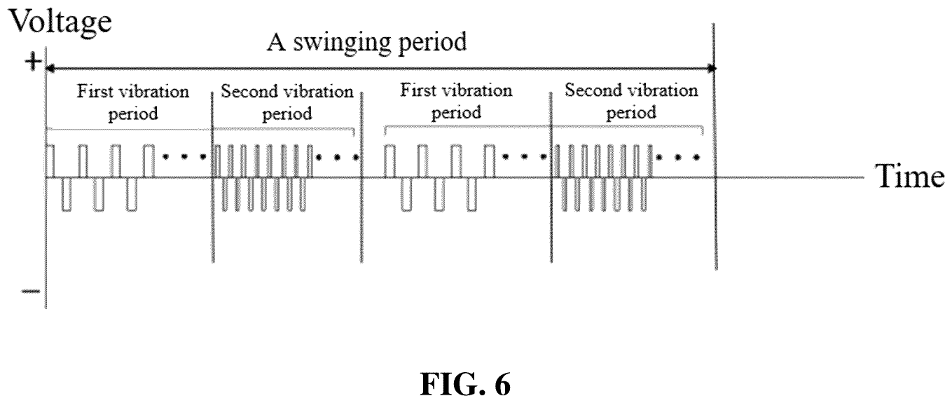

For example, referring to driving waveforms of the vibrating action shown in FIG. 6, a swinging period includes two first vibration periods and two second vibration periods, and the first vibration periods and the second vibration periods are alternately arranged.

In this case, for different swing-vibration levels corresponding to mode 1, pulse durations of a same driving period are different, thus achieving the adjustment of different vibration intensities. For example, for different swing-vibration levels, t1 and t3 in FIG. 3 are different.

Optionally, the duration of the first vibration period is the same as or different from the duration of the second vibration period. For example, in the driving waveform shown in FIG. 6, the duration of the first vibration period is 3 seconds, and the duration of the second vibration period is 1 second, that is, the duration of the first vibration period is greater than the duration of the second vibration period.

In mode 2, the variation manner of the first vibration intensity is different from the variation manner of the second vibration intensity. Exemplarily, the first vibration intensity within the first vibration period varies, and the second vibration intensity within the second vibration period remains unvaried.

Optionally, the first vibration intensity corresponding to the first vibration period varying, includes: a first sub-vibration intensity within a first sub-period of the first vibration period, and a second sub-vibration intensity within a second sub-period of the first vibration period, where the first sub-period and the second sub-period alternate with each other within the first vibration period, and the first sub-vibration intensity being different from the second sub-vibration intensity.

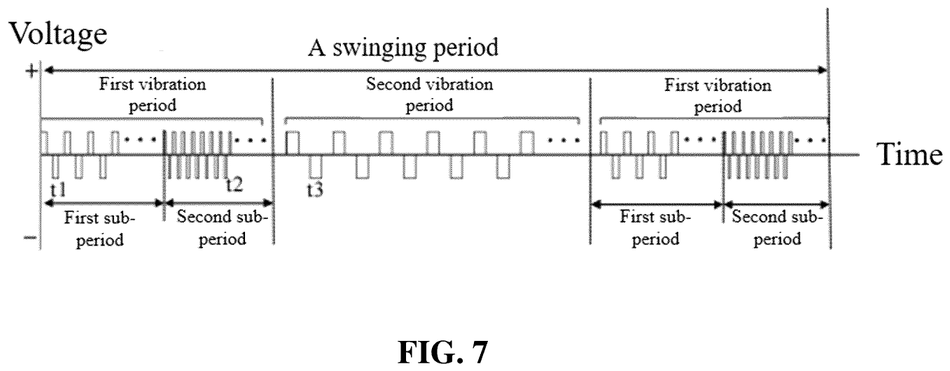

For example, referring to the driving waveforms of the vibrating action shown in FIG. 7, a swinging period includes two first vibration periods ΣT1 and a second vibration period ΣT2. The first vibration period ΣT1 includes two sub-periods that are respectively the first sub-period and the second sub-period. A pulse duration of a driving period within the first sub-period is t1, and a pulse duration of a driving period within the second sub-period is t2, where t1>t2. Therefore, the first sub-vibration intensity within the first sub-period is greater than the second sub-vibration intensity within the second sub-period. The pulse duration of each driving period within the second vibration period ΣT2 is t3, that is, the second vibration intensity within the second vibration period ΣT2 remains unvaried. In this case, the first vibration intensity varies, but the second vibration intensity remains unvaried.

In other implementations, the first sub-vibration intensity can also be less than the second sub-vibration intensity. The variation manner of the first sub-vibration intensity and the second sub-vibration intensity is not limited in this embodiment.

FIG. 7 illustrates an example where a swinging period includes two first vibration periods ΣT1 and a second vibration period ΣT2. In an actual implementation, a swinging period may also include one or at least three first vibration periods ΣT1, or at least two second vibration periods ΣT2. The numbers of the first vibration period ΣT1 and the second vibration period ΣT2 within the swinging period are not limited in this embodiment.

In this case, for different swing-vibration levels corresponding to mode 2, pulse durations of a same driving period are different, thus achieving the adjustment of different vibration intensities. For example, for different swing-vibration levels, t1, t2, and t3 in FIG. 7 are different.

Optionally, the duration of the first vibration period is the same as or different from the duration of the second vibration period. For example, in FIG. 6, the duration of the first vibration period is 1 second, and the duration of the second vibration period is 2 seconds. In other implementations, the durations of the first vibration period and the second vibration period can also have other values. The setting manner of the duration is not limited in this embodiment.

In mode 3, the first vibration intensity is different from the second vibration intensity, the first vibration intensity corresponding to the first vibration period varies, and the second vibration intensity corresponding to the second vibration period varies.

Optionally, the first vibration intensity corresponding to the first vibration period varying, includes: the first sub-vibration intensity within the first sub-period of the first vibration period, the second sub-vibration intensity within the second sub-period of the first vibration period, the first sub-period and the second sub-period alternating with each other within the first vibration period. and the first sub-vibration intensity being different from the second sub-vibration intensity. The second vibration intensity corresponding to the second vibration period varying, includes: a third sub-vibration intensity within a third sub-period of the second vibration period, a fourth sub-vibration intensity within a fourth sub-period of the second vibration period, the third sub-period and the fourth sub-period alternating with each other within the second vibration period, and the third sub-vibration intensity being different from the fourth sub-vibration intensity.

In this case, when the first vibration intensity is greater than the second vibration intensity, the first sub-vibration intensity is greater than the third sub-vibration intensity and the fourth sub-vibration intensity, and the second sub-vibration intensity is greater than the third sub-vibration intensity and the fourth sub-vibration intensity; when the first vibration intensity is less than the second vibration intensity, the first sub-vibration intensity is less than the third sub-vibration intensity and the fourth sub-vibration intensity, and the second sub-vibration intensity is less than the third sub-vibration intensity and the fourth sub-vibration intensity.

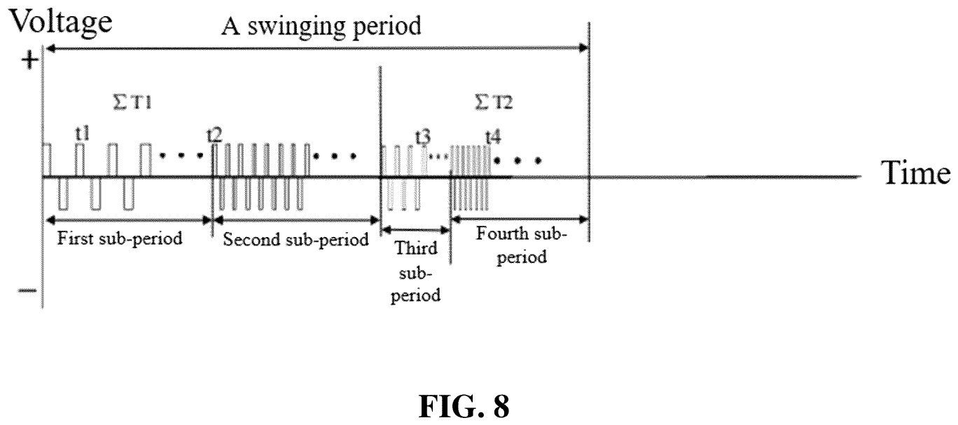

For example, referring to the driving waveforms of the vibrating action shown in FIG. 8, a swinging period includes a first vibration period ΣT1 and a second vibration period ΣT2. The first vibration period ΣT1 includes two sub-periods that are respectively a first sub-period and a second sub-period. A pulse duration of a driving period in the first sub-period is t1, and a pulse duration of a driving period in the second sub-period is t2, where t1>t2. Therefore, the first sub-vibration intensity within the first sub-period is greater than the second sub-vibration intensity within the second sub-period. The second vibration period ΣT2 includes two sub-periods that are respectively a third sub-period and a fourth sub-period. A pulse duration of a driving period within the third sub-period is t3, and a pulse duration of a driving period within the fourth sub-period is t4, where t3>t4. Therefore, the third sub-vibration intensity within the third sub-period is greater than the fourth sub-vibration intensity within the fourth sub-period. That is, in this case, the first vibration intensity is greater than the second vibration intensity.

In this case, for different swing-vibration levels corresponding to mode 3, pulse durations of a same driving period are different to achieve the adjustment of different vibration intensities. For example, for different swing-vibration levels, t1, t2, t3, and t4 in FIG. 8 are different.

Optionally, the duration of the first vibration period is the same as or different from that of the second vibration period. The setting manner of the duration is not limited in this embodiment.

Optionally, in mode 2 and mode 3, the variation of the first vibration intensity corresponding to the first vibration period can also be a continuous variation, and/or the variation of the second vibration intensity corresponding to the second vibration period can also be a continuous variation. The continuous variation means that pulse durations of two adjacent driving periods are different.

As an example, the continuous variation includes continuously increasing first and then continuously decreasing. For example, a swinging period includes a first vibration period ΣT1 and a second vibration period ΣT2. Pulse durations of two adjacent driving periods within the first vibration period ΣT1 increase first and then decrease. Correspondingly, the first vibration intensity within the first vibration period ΣT1 increases continuously first and then decreases continuously. Pulse durations of two adjacent driving periods within the second vibration period ΣT2 also increase first and then decrease. Correspondingly, the second vibration intensity within the second vibration period ΣT2 increases continuously first and then decreases continuously. If the first vibration intensity is greater than the second vibration intensity, pulse durations of driving periods within the first vibration period ΣT1 are overall greater than pulse durations of driving periods within the second vibration period ΣT2. In other words, a pulse duration of a first driving period within the first vibration period ΣT1 is greater than a pulse duration of a first driving period within the second vibration period ΣT2, a pulse duration of a second driving period within the first vibration period ΣT1 is greater than a pulse duration of a second driving period within the second vibration period ΣT2, . . . , in a repetitive manner.

In this case, by adjusting the durations of the first vibration period and the second vibration period, different swing-vibration levels in a same swing-vibration mode can be set.

In a second manner, each swinging period of the swinging action includes vibration period(s), i.e., third vibration period(s) below, and a vibration intensity within a third vibration period varies continuously. A duration of the third vibration period is less than or equal to the duration of the swinging period of the swinging action. Optionally, a swinging period includes one or at least two third vibration periods. The number of the third vibration period(s) within each swinging period is not limited in this embodiment.

Correspondingly, during performing the swinging action, controlling the cleaning component to perform the vibrating action at different vibration intensities based on the operating time of the target swing-vibration mode includes: during performing the swinging action, controlling the cleaning component to perform the vibrating action at a vibration intensity that continuously varies based on operating time falling within a preset third vibration period.

Exemplarily, the oral cleaning device generates a driving waveform corresponding to the third vibration period in a time sequence of each swinging period of the swinging action. In a process of controlling the cleaning component to perform the vibrating action, the continuously varying vibrating action corresponding to the driving waveform is performed with the variation of the operating time.

In an example, the vibration intensity continuously varies within the third vibration period includes: continuously increasing from a third vibration intensity to a fourth vibration intensity, and then continuously decreasing from the fourth vibration intensity to the third vibration intensity.

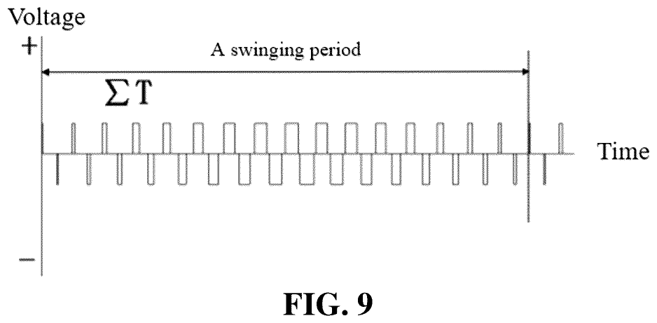

For example, referring to the driving waveform of the vibrating action shown in FIG. 9, a swinging period includes a third vibration period ΣT. Pulse durations of two adjacent driving periods within the third vibration period ΣT increase continuously first, so as to realize continuous increase from the third vibration intensity to the fourth vibration intensity; and then, pulse durations of two adjacent driving periods decrease continuously, so as to realize continuous decrease from the fourth vibration intensity to the third vibration intensity.

In this case, by adjusting the duration of the third vibration period ΣT, different swing-vibration levels in a same swing-vibration mode can be set. For example, a third vibration period ΣT of a first level is 2.6 seconds, a third vibration period ΣT of a second level is 1.3 seconds, and a third vibration period ΣT of a third level is 0.6 seconds. In an actual implementation, the number of swing-vibration levels can also be more or less, and a third vibration period ΣT corresponding to each swing-vibration level can also have other values. The setting manner of the swing-vibration levels in the second manner is not limited in this embodiment.

In other implementations, the first cross-vibration manner and the second cross-vibration manner can also be combined. That is, a same swing-vibration period includes at least one of the first cross-vibration manners, and incudes the second cross-vibration manner.

In summary, in the method for controlling the oral cleaning device provided in this embodiment, the cleaning component of the oral cleaning device is controlled to perform the swinging action when the instruction to start the target swing-vibration mode is obtained; and during performing the swinging action, the cleaning component is controlled to perform the vibrating action at different vibration intensities based on the operating time of the target swing-vibration mode. Therefore, the independent control of the vibration intensity through the time logic is achieved, so that the cleaning component can achieve the cross-variation of the vibration intensity according to the operating time during the entire swinging period, thereby achieving the strong-weak alternation of the vibration intensity while swinging, and reducing an excessive stimulation or damage possibly caused by a single-intensity vibration. A strong vibration is capable of providing effectively cleaning, and a weak vibration gives an oral cavity a certain rest time. This avoids a potential damage to gums and teeth caused by a continuous high-intensity vibration, thereby reducing a risk of problems such as gum bleeding and tooth sensitivity caused by improper brushing, improving a cleaning efficiency, and providing more accurate and flexible cleaning capabilities.

Since appropriate brushing force and manner are crucial for oral health, an excessive brushing force may damage the gums and tooth surface, and an excessively light brushing force may not effectively clean. Therefore, in this embodiment, the control method using the cross-variation of the vibration intensity is capable of ensuring a moderate and uniform brushing force to reduce the risk of damage to the oral cavity, thereby better protecting the oral health.

Moreover, the multi-mode and multi-level adjustment function allows users to adjust the brushing mode according to their own needs and comfort. For example, a deep cleaning mode is suitable for users who need thorough cleaning, and a daily cleaning mode is suitable for daily use. In this way, personalized oral cleaning needs of users can be met, thereby improving the comfort of oral cleaning.

In a possible implementation, the number of the swing-vibration level(s) corresponding to each cross-vibration manner above and the vibration intensity corresponding to each swing-vibration level can be set by users individually. For example, other electronic devices communicatively connected to the oral device display a level configuration interface. The level configuration interface is used to set the swing-vibration levels to which each swing-vibration mode corresponds and the vibration intensities to which each swing-vibration level corresponds. After setting operations for the swing-vibration levels and the swing-vibration intensities are received, level information of the swing-vibration levels and swing-vibration intensity information of each swing-vibration level are sent to the oral cleaning device, so that the oral cleaning device provides the level information, and generates corresponding driving waveforms according to the swing-vibration intensities corresponding to the level information, so as to perform the swing-vibration according to the swing-vibration intensities.

In this embodiment, by individually customizing the swing-vibration levels to which each swing-vibration mode corresponds and the vibration intensities to which each swing-vibration level corresponds, the personalized oral cleaning needs of users can be met, thereby improving the cleaning flexibility of the oral cleaning device.

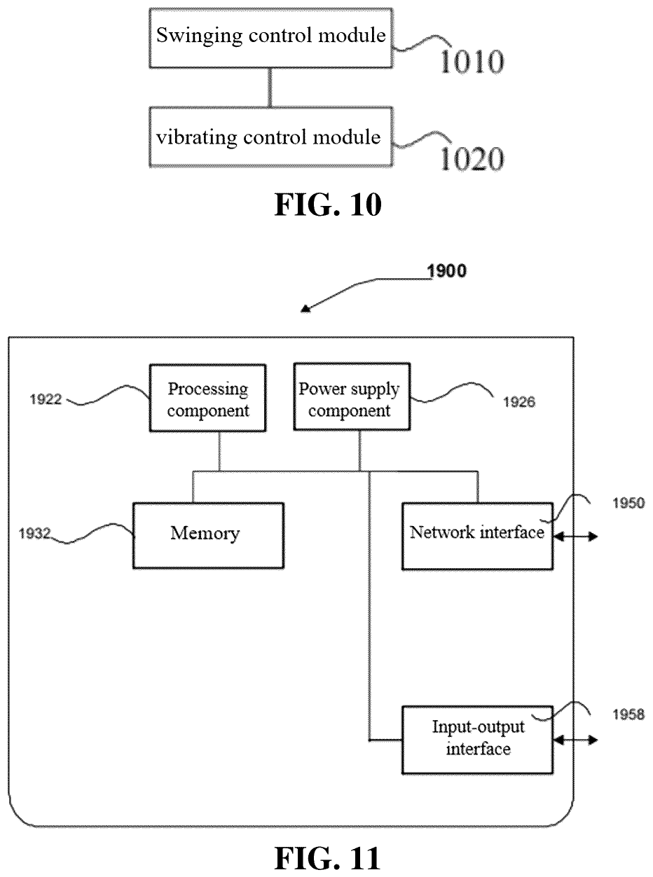

FIG. 10 shows a block diagram of an apparatus for controlling an oral cleaning device according to an embodiment of the present disclosure. In this embodiment, the apparatus is illustrated as an example for use in the oral cleaning device shown in FIG. 1. The apparatus at least includes a swinging control module 1010 and a vibrating control module 1020.

The swinging control module 1010 is configured to control the cleaning component of the oral cleaning device to perform the swinging action when obtaining the instruction to start the target swing-vibration mode.

The vibrating control module 1020 is configured to control the cleaning component to perform the vibrating action at different vibration intensities based on the operating time of the target swing-vibration mode during performing the swinging action.

In some embodiments, the functions or modules included in the apparatus provided in the embodiment of the present disclosure can be used to execute the method described in the above method embodiments, and the specific implementation can refer to the description of the above method embodiments, which is not repeated here for brevity.

A computer-readable storage medium is further provided in an embodiment of the present disclosure, on which computer program instructions are stored. When the computer program instructions are executed by a processor, the above method is implemented. The computer-readable storage medium can be a volatile or non-volatile computer-readable storage medium.

An electronic device is further proposed in an embodiment of the present disclosure. The electronic device includes a processor and a memory for storing instructions executable by the processor. The processor is configured to implement the above method when executing the instructions stored in the memory.

A computer program product is further provided in an embodiment of the present disclosure. The computer program product includes a computer-readable code, or a non-volatile computer-readable storage medium carrying the computer-readable code. When the computer-readable code runs in a processor of an electronic device, the processor in the electronic device executes the above method.

FIG. 11 is a block diagram of an apparatus 1900 for controlling an oral cleaning device shown according to an exemplary embodiment. For example, the apparatus 1900 can be provided as the oral cleaning device or a terminal device communicatively connected to the oral cleaning device. Referring to FIG. 11, the apparatus 1900 includes a processing component 1922 (which further includes one or more processors, and the processor can be the control module 120 in the oral cleaning device shown in FIG. 1) and a memory resource represented by a memory 1932 for storing instructions executable by the processing component 1922, such as application programs. The application programs stored in the memory 1932 can include one or more modules each corresponding to a set of instructions. In addition, the processing component 1922 is configured to execute the instructions to execute the above method.

The apparatus 1900 can further include a power supply component 1926 configured to perform a power management of the apparatus 1900, a wired or wireless network interface 1950 configured to connect the apparatus 1900 to a network, and an input-output interface 1958 (I/O interface). The apparatus 1900 can operate based on an operating system stored in the memory 1932, such as Windows Server™, Mac OS X™, Unix™, Linux™, FreeBSD™, or the like.

In an exemplary embodiment, a non-volatile computer-readable storage medium is further provided, such as the memory 1932 including computer program instructions. The above computer program instructions can be executed by the processing component 1922 of the apparatus 1900 to complete the above method.

The embodiments of the present disclosure are described above. The foregoing description is exemplary, not exhaustive, and is not limited to the disclosed embodiments. Many modifications and variations are apparent to those of ordinary skill in the art without departing from the scope and spirit of the described embodiments. The terminology used herein is chosen to best explain the principles of the embodiments, practical applications, or technical improvements in the market, or to enable other ordinary skilled in the art to understand the embodiments disclosed herein.

What is claimed is:

1. A method for controlling an oral cleaning device, wherein the method comprises:
controlling a cleaning component of the oral cleaning device to perform a swinging action when an instruction to start a target swing-vibration mode is obtained; and
controlling the cleaning component to perform a vibrating action at different vibration intensities based on operating time of the target swing-vibration mode during performing the swinging action.

2. The method according to claim 1, wherein the controlling the cleaning component to perform the vibrating action at different vibration intensities based on the operating time of the target swing-vibration mode during performing the swinging action, comprises:
controlling the cleaning component to perform the vibrating action at a first vibration intensity in response to the operating time falls within a preset first vibration period during performing the swinging action; and
controlling the cleaning component to perform the vibrating action at a second vibration intensity in response to the operating time falls within a preset second vibration period during performing the swinging action, wherein
the first vibration period and the second vibration period alternate with each other, and a sum of durations of the first vibration period and the second vibration period is less than or equal to a duration of a swinging period of the swinging action; the first vibration intensity is different from the second vibration intensity; and/or a variation manner of the first vibration intensity is different from a variation manner of the second vibration intensity.

3. The method according to claim 2, wherein
the first vibration intensity corresponding to the first vibration period varies or remains unvaried; and/or
the second vibration intensity corresponding to the second vibration period varies or remains unvaried.

4. The method according to claim 3, wherein
the first vibration intensity corresponding to the first vibration period varying, comprises: a first sub-vibration intensity within a first sub-period of the first vibration period, a second sub-vibration intensity within a second sub-period of the first vibration period, and the first sub-period and the second sub-period alternating with each other within the first vibration period; and the first sub-vibration intensity being different from the second sub-vibration intensity; and
the second vibration intensity corresponding to the second vibration period varying, comprises: a third sub-vibration intensity within a third sub-period of the second vibration period, a fourth sub-vibration intensity within a fourth sub-period of the second vibration period, and the third sub-period and the fourth sub-period alternating with each other within the second vibration period; and the third sub-vibration intensity being different from the fourth sub-vibration intensity; wherein
in a case where the first vibration intensity is greater than the second vibration intensity, the first sub-vibration intensity is greater than the third sub-vibration intensity and the fourth sub-vibration intensity; and the second sub-vibration intensity is greater than the third sub-vibration intensity and the fourth sub-vibration intensity; and
in a case where the first vibration intensity is less than the second vibration intensity, the first sub-vibration intensity is less than the third sub-vibration intensity and the fourth sub-vibration intensity; and the second sub-vibration intensity is less than the third sub-vibration intensity and the fourth sub-vibration intensity.

5. The method according to claim 1, wherein the controlling the cleaning component to perform the vibrating action at different vibration intensities based on the operating time of the target swing-vibration mode during performing the swinging action, comprises:
controlling the cleaning component to perform the vibrating action at a vibration intensity that continuously varies based on the operating time falling within a preset third vibration period during performing the swinging action, wherein
a duration of the third vibration period is less than or equal to a duration of a swinging period of the swinging action.

6. The method according to claim 5, wherein the vibration intensity continuously varying within the third vibration period comprises: continuously increasing from a third vibration intensity to a fourth vibration intensity, and then continuously decreasing from the fourth vibration intensity to the third vibration intensity.

7. The method according to claim 1, wherein the oral cleaning device comprises at least two swing-vibration modes, and different swing-vibration modes correspond to different swing-vibration strategies; a swing-vibration strategy is configured to indicate a manner of performing the swinging action and the vibrating action; and
correspondingly,
the method further comprises:
receiving a mode selection operation for the target swing-vibration mode in the at least two swing-vibration modes; and
generating the instruction to start the target swing-vibration mode based on the mode selection operation, so as to control the cleaning component to perform the swinging action and the vibrating action according to a swing-vibration strategy corresponding to the target swing-vibration mode.

8. The method according to claim 7, wherein the target swing-vibration mode comprises at least two swing-vibration levels, and different swing-vibration levels in a same swing-vibration mode correspond to different vibration intensities;
correspondingly,
the generating the instruction to start the target swing-vibration mode based on the mode selection operation, comprises:
receiving a level selection operation for a target swing-vibration level in the at least two swing-vibration levels; and
generating the instruction to start the target swing-vibration mode based on the mode selection operation and the level selection operation, so as to control the cleaning component to perform the swinging action and the vibrating action according to the swing-vibration strategy corresponding to the target swing-vibration mode and a vibration intensity corresponding to the target swing-vibration level.

9. An apparatus for controlling an oral cleaning device, comprising:
a processor; and
a memory for storing instructions executable by the processor, wherein
the processor is configured to implement the method according to claim 1 when executing the instructions stored in the memory.

10. The apparatus according to claim 9, wherein the processor comprises a main control chip and a driving chip connected to the main control chip; the driving chip is connected to a driving structure in the cleaning component;
the main control chip is configured to send the instruction to start the target swing-vibration mode to the driving chip; and
correspondingly, the driving chip is configured to control the cleaning component of the oral cleaning device to perform the swinging action when obtaining the instruction to start the target swing-vibration mode; and control the cleaning component to perform the vibrating action at different vibration intensities based on the operating time of the target swing-vibration mode during performing the swinging action.

11. The apparatus according to claim 10, wherein the driving chip comprises a processing unit and driving units; correspondingly,
the main control chip is configured to send the instruction to start the target swing-vibration mode to the processing unit based on a preset communication protocol, wherein the instruction carries mode data corresponding to the target swing-vibration mode; and
the processing unit is configured to decode the instruction when obtaining the instruction to start the target swing-vibration mode based on the preset communication protocol; and control the driving units to drive the driving structure to move based on decoded information, so that the cleaning component performs the swinging action and the vibrating action.

12. The apparatus according to claim 11, wherein the driving structure comprises sensors, and sensing data collected by the sensors are configured to indicate a movement position of the driving structure; the sensors are in one-to-one correspondence with the driving units; correspondingly,
the driving units are further configured to obtain sensing data collected by respective sensors and send the sensing data to the processing unit; and
the processing unit is further configured to analyze and process the sensing data when receiving the sensing data fed back by the driving units, and control the driving units to drive the driving structure to move according to the target swing-vibration mode based on a processing result.

13. The apparatus according to claim 10, wherein the driving chip comprises driving units connected to the main control chip; correspondingly,
the main control chip is configured to send the instruction to start the target swing-vibration mode to the driving units; the instruction is configured to indicate a movement manner of the driving structure; and
the driving units are configured to drive the driving structure to move based on the instruction when obtaining the instruction to start the target swing-vibration mode, so that the cleaning component performs the swinging action and the vibrating action.

14. The apparatus according to claim 13, wherein the driving structure comprises sensors, and sensing data collected by the sensors are configured to indicate a movement position of the driving structure; the sensors are in one-to-one correspondence with the driving units; correspondingly,
the driving units are further configured to obtain sensing data collected by respective sensors, analyze the sensing data to obtain analyzed sensing data, and send the analyzed sensing data to the main control chip; and
the main control chip is further configured to process the analyzed sensing data when receiving the analyzed sensing data fed back by the driving units, and control the driving units to drive the driving structure to move according to the target swing-vibration mode based on a processing result.

15. A non-volatile computer-readable storage medium storing computer program instructions, wherein the computer program instructions, when executed by a processor, implement the method according to claim 1.

16. The method according to claim 2, wherein the oral cleaning device comprises at least two swing-vibration modes, and different swing-vibration modes correspond to different swing-vibration strategies; a swing-vibration strategy is configured to indicate a manner of performing the swinging action and the vibrating action; and
correspondingly,
the method further comprises:
receiving a mode selection operation for the target swing-vibration mode in the at least two swing-vibration modes; and
generating the instruction to start the target swing-vibration mode based on the mode selection operation, so as to control the cleaning component to perform the swinging action and the vibrating action according to a swing-vibration strategy corresponding to the target swing-vibration mode.

17. The apparatus for controlling an oral cleaning device, comprising:
a processor; and
a memory for storing instructions executable by the processor, wherein the processor is configured to implement the method according to claim 2 when executing the instructions stored in the memory.

18. The non-volatile computer-readable storage medium storing computer program instructions, wherein the computer program instructions, when executed by a processor, implement the method according to claim 2.
